(19) United States
(12) Patent Application Publication
(10) Pub. No.: US 2008/0177828 A1
(43) Pub. Date: Jul. 24, 2008

(54) Method For The Management Of Access To At Least One Content And/Or At Least One Service, Corresponding Computer Program Product, Storage Means And Access Device

(75) Inventors: Jean-Paul Accarie, Vern Sur Seiche (FR); Stephane Bizet, Liffre (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/014,838

(22) Filed: Jan. 16, 2008

(30) Foreign Application Priority Data
Jan. 19, 2007 (FR) 07 00381

(51) Int. Cl. G06F 15/16

(52) U.S. Cl. 709/203

(57) ABSTRACT

A method for the management of devices in a communications network comprises at least one source device and at least one destination device, the destination device or devices being interconnected to the source device or devices by means of at least one other device of the network called an access device or devices. This method comprises the following steps implemented by an access device compatible with a predetermined audiovisual content description format: reception of a request, coming from a destination device, called a requesting destination device, for obtaining a list of audiovisual contents available on the access device; creation of a list, called a requested list, comprising a piece of information representing at least one source device, the representative information being described according to the audiovisual content description format; in response to the request, sending the requesting destination device the list created during the creation step.

### 1. FIELD OF THE INVENTION

The field of the invention is that of data communications networks. More particularly, the invention relates to the management of access to data and services implemented in such networks.

More specifically, the invention can be applied especially but not exclusively in a home communications network comprising a plurality of access devices for the interconnection of a plurality of analog and/or digital type audio and/or video terminals (also called devices) in order that they may exchange audiovisual signals. The terminals belong for example to the following list of devices (which is not exhaustive): television receivers (using satellite, RF channels, cable, xDSL and other means), digital television sets, D-VHS videocassette recorders, DVD players, hard disk drives etc.

Thus, the invention can be applied, for example, in the case of communications networks using the IEEE 1394.1 standard which enables the interconnection of several IEEE 1394 type buses thus enabling communications among the different types of IEEE 1394 devices connected to these buses. Each bus may, for example, interconnect several IEEE 1394 devices in a same room.

It is also possible to consider an audio-video network (installed for example in a house) that implements the communications technologies of the IP protocol (wired or wireless technologies using the Ethernet 802.3 standard, WiFi 802.11b standard etc), i.e. a network in which the specific access device may interconnect an IEEE 1394 type source or sink device with one of the IP (Internet Protocol) type devices.

### 2. PRIOR ART

The drawbacks of the prior art techniques shall now be presented in the above-mentioned particular case of home networks using the IEEE 1394 and IEEE 1394.1 standards. The IEEE 1394.1 document, “Draft Standard for High-Performance Bus Bridges” May 2004, describes the working and architecture of bridge type devices and terminal type devices for the interconnection of several IEEE 1394 type buses.

To build a communications network working according to the IEEE 1394 and 1394.1, standards and thus be able to access the contents of the devices connected to such a network, the devices connected to the network must all be capable of understanding and interpreting the data transmitted on the network.

Thus, an IEEE 1394 compliant device implementing the specifications requested by the 1394.1 standard to detect and communicate through IEEE 1394.1 bridges is known as a device compatible with the IEEE 1394.1 standard (or a 1394.1 aware device or bridge aware device).

In such a context, each access device is not only a device compatible with the IEEE 1394.1 standard but also constitutes an IEEE 1394.1 bridge made up of two portals in the sense that each one manages all the IEEE 1394.1 operations of the IEEE 1394 bus connected to it.

In addition to knowing the existence of any remote IEEE 1394 source or sink device and enabling the management of such a device, these access devices can also provide specific services, for example “send data streams being received to other access devices”, “lock access to the device A”, “program a deferred recording”, etc.

Today, existing digital television sets compliant with the IEEE 1394 standard are generally capable of controlling a limited list of IEEE 1394 source devices such as IEEE 1394 type audio-video hard disk drives (AV HDD) and IEEE 1394 type digital videocassette recorders (D-VHS). However, they are not compliant with the IEEE 1394.1 standard and therefore cannot communicate with source devices connected to buses other than those to which they are connected, nor can they benefit from services of the network to which they are connected. An IEEE 1394 digital television set can display only the list of contents of the AV HDD that are directly connected to the same IEEE 1394 bus as itself and will not have knowledge of the contents of the AV HDDs are connected to an IEEE 1394 bus separated from it by at least one IEEE 1394.1 bridge.

Similarly, in the other case mentioned here above of an audio-video network implementing the communications technologies of the IP protocol, it can happen that an IEEE 1394 digital television set is unable to detect the existence of the IP devices connected to the network and of the potential services associated with the network.

Thus, one drawback of this prior art approach is that it does not allow a destination device compliant with the IEEE 1394 standard (for example an IEEE 1394 compliant digital television set) to detect and use source devices if these devices are not connected to the same bus as itself. In the present description, the storage devices (AV HDDs for example) are considered to be a sub-category of the source devices.

Another drawback of the prior art approach is that it does not allow an IEEE 1394 destination device (for example an IEEE 1394 compliant digital television set) connected to the network to benefit from all the services available on the network, such as for example a recording on a distant or remote hard disk drive).

Yet another drawback of the prior art approach is that the user cannot control all the remote devices (hard disk drives, VCR, STB decoder etc) connected to the home communications network solely from his IEEE 1394 destination device (for example an IEEE 1394 digital television set).

Another drawback of the prior art approach is that the IEEE 1394.1 compatible devices all have knowledge of the localized devices on IEEE 1394 buses that are distinct and separated by IEEE 1394.1 compliant bridges, whereas many display devices which provide means of interaction with the user are not IEEE 1394.1 compatible).

### 3. GOALS OF THE INVENTION

The invention in at least one embodiment is aimed especially at overcoming these different drawbacks of the prior art.

More specifically, one of the goals of the present invention, in at least one embodiment, is to provide a technique by which remote source devices can be made visible to a destination device (for example an IEEE 1394 digital television set) provided with a graphic user interface for the control of at least one other device, the source and destination devices being both connected to one and the same communications network.

It is also a goal of the invention, in at least one embodiment, to provide a technique of this kind enabling a user to access content of the remote source devices of such a communications network from the above-mentioned destination device (for example an IEEE 1394 digital television set).

It is also a goal of the invention, in at least one embodiment, to provide a technique of this kind enabling the user of the above-mentioned destination device (for example of an IEEE 1394 digital television set) connected to a communications network, to benefit from the services of this network.

It is another goal of the invention, in at least one embodiment of the invention, to provide a technique of this kind that is simple to implement and costs little.

It is an additional goal of the invention, in at least one embodiment, to provide a technique of this kind that does not require a modification of the destination devices (for example IEEE 1394 television sets) provided with an interface for the control of at least one other device.

### 4. SUMMARY OF THE INVENTION

One particular embodiment of the invention proposes a method for the management of devices in a communications network comprising at least one source device and at least one destination device, said destination device or devices being interconnected to said source device or devices by means of at least one other device of said network, called an access device or access devices.

According to the invention, such a method comprises the following steps implemented by an access device compatible with a predetermined audiovisual content description format:
reception of a request, coming from a destination device, called a requesting destination device, for obtaining a list of audiovisual contents available on said access device;
creation of a list, called a requested list, comprising a piece of information representing at least one source device, said representative information being described according to said audiovisual content description format;
in response to said request, sending said requesting destination device the list created during the creation step.

The general principle of the invention consists in providing an access device such that:
this access device emulates a device (for example an audio-video hard disk drive) capable of being controlled by the destination device (for example an IEEE 1394 digital television set). Thus, the access device processes and responds to a request sent by the destination device for obtaining a list of contents (also called tracks) in compliance with a predetermined audiovisual content description format.
this access device is capable of searching for (and therefore inserting into a list of contents) contents that are not all visible to the destination device, and/or searching for source devices that are themselves connected to the network but are not all visible to the destination device. Thus, the device makes these contents and/or these source devices visible to the destination device.

It must be noted that, in response to the request from the destination device for obtaining the list of contents, the list sent (also called a requested list) includes a piece of representative information used to identify and describe the source devices connected to the network.

Advantageously, prior to the step for creating the requested list, the device management method comprises a step for determining at least one source device which is a storage device, on which at least one audiovisual content is available, the requested list then furthermore comprising a piece of information representing said audiovisual content or contents available on said determined storage device or devices.

Thus, the requested list sent by the access device to the destination device may also include a piece of information representing the content of a hard disk drive type source device such as the name or the title of the content.

Advantageously, the piece of information representing said determined storage device or devices is excluded from the requested list.

Thus, for each storage device, the requested list does not include any information representative of this device (for example the name) but only pieces of information representing the contents available on this device (for example the title of a film).

According to an advantageous characteristic, prior to the step for creating the requested list, the device management method comprises a step for determining at least one service available on the network, the requested list then furthermore comprising a piece of information representing said determined service or services, said representative piece of information being described according to said audiovisual content description format.

It is thus possible to index all the services available on the network to which the user of the destination device could have access, such services taking account of the specific features of the source devices and/or of the destination devices connected to the network.

In a particular embodiment of the invention, the device management method comprises a preliminary step for the declaration of said access device as a storage device of a predetermined type, said reception step and said sending step being performed according to a standard protocol for the control of a storage device of said predetermined type.

Thus, communications between the destination device and the access device emulating a content provider device is achieved according to a standard control protocol (example the protocol conventionally implemented between an IEEE 1394 digital television set and an IEEE 1394 audio-video hard disk drive). The following standard control protocols in particular may be cited by way of examples:

TA Document 2001012 “AV/C Digital Interface Command Set General Specification Version 4.1”, 1394 Trade Association, 11 Dec. 2001;

TA Document 2001021 “AV/C Descriptor Mechanism Specification 1.1”, 1394 Trade Association, 20 Feb. 2002;

TA Document 2001022, “AV/C Disc Subunit General Specification 1.1”, 1394 Trade Association, 20 Feb. 2002;

TA Document 2001023, “AV/C Disc Subunit-Hard Disk Drive Device Type”, 1394 Trade Association, 20 Feb. 2002.

Advantageously, the device management method furthermore comprises the following steps:
reception of a first control request, coming from said requesting destination device, associated with an element, called a selected element, of the requested list;
determining a content, a source device or a service available on the network, called a represented element, the selected element of which is the piece of representative information;
determining the operations to be performed as a function of the determined content, source device or service and of the control request received.

Thus, the user of the destination device may send a control request in selecting an element of the requested list by means of a control device (a remote control unit for example).

Advantageously, should the represented element to be a source device, the step for determining the operations to be performed comprises the following step:
sending said source device a command corresponding to the received control request, according to a rule of correspondence between received requests and commands applicable to said source device.

In this way, the access device can control the source device or devices concerned by the request from the user of the destination device, in implementing commands proper to the source device or devices concerned.

According to an advantageous characteristic, if the represented element is a content, the step for determining the operations to be performed comprises the following steps:
determining a storage device on which said content is stored;
determining whether a stream connection has been set up between said storage device and the requesting destination device;
if the determining result is negative, sending a request for setting up a stream connection between said storage device and the requesting destination device;
sending said storage device a command corresponding to the control request received, according to a rule of correspondence between received requests and commands applicable to said storage device.

Thus, when the selected element selected by the user is the content, a connection is set up between the destination device and the source device, and a command is sent to the storage device to provide the user with the requested content.

In an advantageous embodiment of the invention, the step for determining the operations to be performed includes the following steps if the represented element is a service:
determining at least one source device and at least one destination device of which said service is a function;
determining at least one stream connection to be set up between said source device or devices and said determined destination device or devices, in order to perform said service;
sending at least one request for setting up said stream connection or connections.

Thus, when the element selected by the user is a service, a connection is set up between the destination device and the source device or devices taking part in the execution of the service in order to perform this service.

Advantageously, the device management method furthermore comprises the following step:
sending at least one of said source devices and said determined destination devices, called service device or devices, a command corresponding to the control request received according to a rule of correspondence between received requests and commands applicable to said service device or devices.

Thus, the service designated by the element selected by the user is activated.

In one particular embodiment of the invention, said requesting destination device is an IEEE 1394 type display device

Thus, it is possible for example to use an IEEE 1394 type digital television set as a destination device. For, a television set of this kind is adapted to the management of access to contents and services available on the network, as a preferred interface between the user and the home audio-video apparatuses.

The invention also relates to a computer program product downloadable from a communications network and/or recorded on a carrier readable by computer and/or executable by a processor comprising program code instructions for the execution of the steps of the device management method as described here above when said program is executed on a computer.

The invention also relates to a totally or partially detachable storage means, readable by a computer, storing a set of instructions executable by said computer to implement the device management method as described here above.

The invention also relates to an access device compatible with a predetermined audiovisual content description format interconnecting one or more destination devices to one more source devices within a communications network, said access device comprising:
means of reception of a request, coming from a destination device, called a requesting destination device, for obtaining a list of audiovisual contents available on said access device;
means of creation of a list, called a requested list, comprising a piece of information representing at least one source device, said representative information been described according to said audiovisual content description format;
means of sending said requesting destination device, in response to said request, the list created during the creation step.

In an advantageous embodiment of the invention, the access device comprises means for determining at least one source device which is a storage device, on which at least one audiovisual content is available, the requested list furthermore comprising a piece of information representing said audiovisual content or contents available on said determined storage device or devices.

Advantageously, the access device comprises means for the exclusion, from the requested list, of the piece of information representing said determined storage device or devices.

Advantageously, the access device comprises means for determining at least one service available on the network, the requested list then furthermore comprising a piece of information representative of said determined service or services, said representative piece of information being described according to said audiovisual content description format.

In a particular embodiment of the invention, the access device comprises means for the declaration of said access device as a storage device of a predetermined type, said reception means and said sending means implementing a standard protocol for the control of a storage device of said predetermined type.

Advantageously, the access device furthermore comprises:
means of reception of a first control request, coming from said requesting destination device, associated with an element, called a selected element, of the requested list;
means of determining a content, a source or a service available on the network, called a represented element, the selected element of which is the piece of representative information;
means of determining the operations to be performed as a function of the determined content, source device or service and of the control request received.

In an advantageous embodiment of the invention, should the represented element to be a source device, said means of determining the operations to be performed comprise means of sending said source device a command corresponding to the received control request, according to a rule of correspondence between received requests and commands applicable to said source device.

Advantageously, if the represented element is a content, the means for determining the operations to be performed comprise:
means of determining a storage device on which said content is stored;
means of determining if a stream connection has been set up between said storage device and the requesting destination device;
if the determining result is negative, means of sending a request for setting up a stream connection between said storage device and the requesting destination device;
means of sending said storage device a command corresponding to the control request received, according to a rule of correspondence between received requests and commands applicable to said storage device.

In an advantageous embodiment of the invention, the means of determining the operations to be performed include the following if the represented element is a service:
means of determining at least one source device and at least one destination device of which said service is a fumction;
means of determining at least one stream connection to be set up between said source device or devices and said determined destination device or devices, in order to perform said service;
means of sending at least one request for setting up said stream connection or connections.

In an advantageous embodiment of the invention, the access device furthermore comprises means of sending at least one of said source devices and said determined destination devices, called service device or devices, a command corresponding to the received control request, according to a rule of correspondence between received requests and commands applicable to said service device or devices.

Advantageously, said requesting destination device is an IEEE 1394 type display device.

### 5. LIST OF FIGURES

Other features and advantages of embodiment of the invention shall appear from the following description, given by way of an indicative and non-restrictive example (the embodiments of the invention are not all limited to the characteristics and advantages of this particular embodiment) and from the appended drawings, of which:

FIGS. 1-a and 1-b respectively represent a first and second home communications network in which it is possible to implement the method according to a particular embodiment for the management of access to at least one content and/or to at least one service available on such networks;

FIG. 2 is a block diagram showing a detailed view of an architecture of an access device according to a particular embodiment of the invention;

FIG. 3 is a flow chart of processing implemented by the access device for the building and updating of a list of contents according to a particular embodiment of the method of the invention;

FIG. 4 illustrates a content emulation description table as used by an access device according to a particular embodiment of the invention;

FIG. 5 is a flow chart of processing implemented by an access device for the execution of a set of commands with a view to obtaining a list of contents or tracks (a “get track list”) according to a particular embodiment of the invention;

FIG. 6 shows a part of an example of a graphic user interface of an IEEE 1394 digital television set according to a particular embodiment of the invention;

FIG. 7 is a flow chart of processing implemented by an access device for the execution of classic audio-video hard disk drive (AV HDD) commands according to a particular embodiment of the method of the invention;

FIG. 8 is a table of correspondence of HDD (hard disk drive) commands used by an access device according to a particular embodiment of the invention.

### 6. DETAILED DESCRIPTION

For the sake of clarity and simplification, the following document shall be limited to the particular embodiment of the invention where the communications network considered is one in which the access devices are IEEE 1394.1 compliant bridges, enabling the connection of several IEEE 1394 type buses with one another, and thus enabling communications between IEEE 1394 devices connected to different buses. It will of course be easy for those skilled in the art to extend this description to any other embodiment of the invention, for example to the case of an audio-video network implementing the communications technologies of the IP protocol.

The general principle of this particular embodiment of the invention is based on the emulation, by a network access device, of an audio-video hard disk drive compliant with the IEEE 1394 standard (or IEEE 1394 AV HDD) capable of communicating with and being controlled by an IEEE 1394 compliant digital television set or any other destination device provided with a graphic user interface, enabling the control of other IEEE 1394 source devices that are connected to it. These other source devices provided with a graphic user interface are, for example, IEEE 1394 monitors, IEEE 1394 camcorders or a PC computer having an IEEE 1394 interface. In this way, through the hard disk drive emulated by the access device, the IEEE 1394 television set, although not compliant with the IEEE 1394 standard, can:
view contents localized on source devices connected to an IEEE 1394 bus other than the one to which the IEEE 1394 digital television set is connected;
see and use source devices that are not connected to the same IEEE 1394 bus as the IEEE 1394 digital television set;
see and use services provided by the network.

The content of certain source devices, the source devices themselves or the services given by the network are made accessible by the selection, through the graphic user interface of the IEEE 1394 digital television set, of one of the contents of the IEEE 1394 type AV HDD emulated by the access device.

Thus, from the viewpoint of the IEEE 1394 digital television set, the access device is perceived as an AV HDD, i.e. it has the characteristics of a classic IEEE 1394 type AV HDD such as the “ROM configuration” and the adapted AV/C (audio-video/command) descriptors, implements an AV/C server and a module for processing requests for the usual and obligatory commands specific to an IEEE 1394 type AV HDD. The access device manages the setting up of a network connection involving any remote device when such connection is requested, in using the IEEE 1394.1 standard.

When the IEEE 1394 digital television set requests the list of contents available on the access device, this access device actually builds a list of contents (this is a loosely coined term) which concatenate different elements, for example:
the names of the content (also called tracks) of certain source devices retrieved from different hard disk drives connected to the network;

the names of the source devices capable of transmitting an audio-video content;
the names of the services provided by the network.

The list of contents given by the access device is interpreted by the IEEE 1394 digital television set as the list of contents (or tracks) of the classic audio-video hard disk drive. The IEEE 1394 digital television set is then capable, by using its graphic user interface of the IEEE 1394 type AV HDD devices, of sending commands to the hard disk drive emulated by the access device.

When it receives the AV/C commands for the control of an AV HDD coming from the IEEE 1394 digital television set, the hard disk drive emulation module of the access device first of all analyses the element of the content lists to which the received command applies in order to execute an appropriate processing operation accordingly, such as for example:
the reading of a content of an AV HDD type source device available on the network: the access device first of all makes connection with the AV HDD concerned and then sends the read command to read the given content; or
connection to a remote source device: the access device first of all makes connection with the concerned remote source device, then sends the appropriate commands so that the source device transmits the given content; or
execution of a service provided by the network: for example a received content is broadcast to all the available display devices of the network.

Thus, the digital television set can benefit from the services provided by the network although it has not been designed for such a use.

When a user interrogates the access device from an IEEE 1394 digital television set, the user, by means of the AV HDD emulation module and through the graphic user interface of the digital television set, actually views a set of contents that differ from a list of contents (or tracks) of a classic AV HDD. Indeed, the user obtains a list of specific elements such as the names of the source devices, the contents stored in the source devices such as the AV HDD devices of the network, as well as the names of the services provided by the network. The user can then navigate within this list and select an element therefrom. The AV HDD emulation module of the access device then applies the appropriate processing depending on the characteristics of the element of the selected list.

In all the figures of the present document, the identical elements and steps are designated by a same numerical reference.

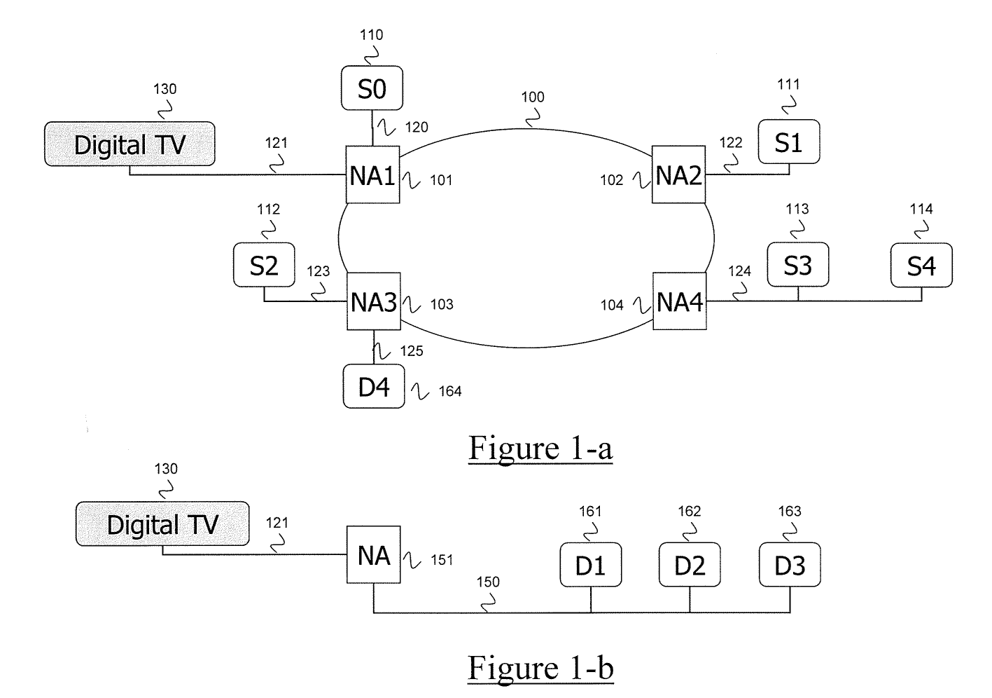

FIG. 1-a represents a first home communications network 100 in which it is possible to implement the method according to a particular embodiment of the invention for the management of access to at least one content and/or at least one service available on this network 100.

The home network 100 comprises network access devices 101 to 104 which are interconnected and may furthermore be connected to different types of source devices through various connection means. These different types of source devices may be, for example, a digital television set 130, a sink device 164 (for example an analog television set), other devices 110 to 114 (for example an STB (set top box) decoder box, a DVD player, a D-VHS digital videocassette recorder etc) and/or storage devices (hard disk drives).

It must furthermore be noted that it is not the purpose of the present document to provide a detailed description of the different home networks. Thus, the use of wire technologies (for example the Ethernet IEEE 802.3 standard, the IEEE 1394 standard etc) and/or wireless technologies (for example the WiFi IEEE 802.11 standard) to set up home communications networks are obvious to those skilled in the art.

An example of such a network is described in the patent application WO 2004/066,557.

FIG. 1 -a shows several devices connected to the home network 100 by means of access devices 101 to 104. Thus, the digital television set 130 is connected to the access device 101 by means of an IEEE 1394 type link 121. Similarly, the devices 111 to 114 are respectively connected to the access devices 102 to 104 by means of IEEE 1394 links (respectively 122 to 124).

Furthermore, the device 110 is connected to the access device 101 by means of an audio-video analog link 120. Similarly, the sink device 164 is connected to the access device 103 by means of an audio-video analog link 125.

FIG. 1-b shows a second multimedia communications home network 150 in which it is possible to implement the method according to a particular embodiment of the invention for the management of access to at least one content and/or at least one service available on the second network.

The second home network 150 interconnects the devices 151 and 161 to 163. As in the case of the first home network 100, the second home network 150 uses wire technologies (for example the Ethernet 802.3 standard, the IEEE 1394 standard, etc) and/or wireless technologies (for example the WiFi IEEE 802.11 b standard). The connected devices 161 to 163 may then directly communicate with one another.

The access device 151 is a particular device which can not only communicate directly with the connected devices 161 to 163 but also play the role of a communications bridge with the digital television set 130 connected to the access device 151 by means of an IEEE 1394 type link referenced 121.

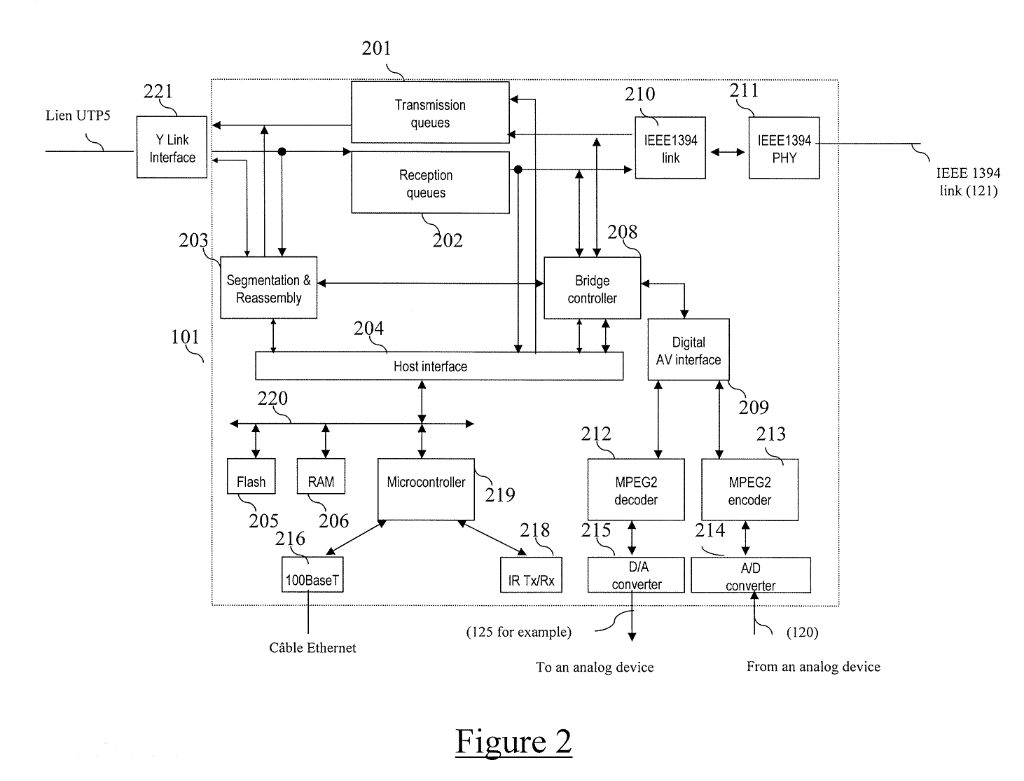

FIG. 2 is a block diagram giving a detailed view of the architecture of a network access device according to one particular embodiment of the invention.

In general, each network access device has a plurality of connection means by which signals of different kinds travel in transit.

The access device 101 has a microcontroller 219 which will transfer data on the bus 220 to RAM (Random Access Memory) type storage means 206.

When the access device is powered on, the microcontroller 219 will load the program contained in the flash memory 305 into the RAM 306 and execute the code associated with this program.

The microcontroller 219 will transfer information coming from the different connection means to a transmission queue referenced 201. This transfer complies with the quality of service required for the transfer of this information. Indeed, the IEEE 1394 type networks enable the exchange of isochronous or asynchronous type data. Isochronous type data is governed by transmission bit rate imperatives while asynchronous type data may be transmitted without transmission bit rate imperatives. The transfer of data according to quality of service requirements is described in the European patent application No. 01400316 and shall not be described in greater detail herein.

The microcontroller 219 has a 100baseT type Ethernet interface 216 connected to it. This interface 216 enables the connection of an Ethernet cable.

An infrared transmission and reception module 218 is also connected to the microcontroller 219. Through this infrared module 218, infrared control signals coming from a remote control unit will be received and then retransmitted by means of the microcontroller 219 to the different apparatuses connected to the network. This transfer of infrared commands is described in the French patent application No. 0110367.

Through the bus interface 204, the microcontroller 219 will also manage the configuration of the transmission parameters associated with each transmission queue, these parameters being stored in the segmentation and reassembly module 203.

For the transmission queues associated with an isochronous type data stream (i.e. “stream mode buffer” type queues), the segmentation and reassembly module 203 ensures the minimum transmission bit rate necessary for the isochronous type data stream from the transmission parameters.

For the transmission queues associated with an asynchronous type data stream (i.e. “message mode buffer” type queues), the segmentation and reassembly module 203 ensures a maximum transmission bit rate for the asynchronous type data from the transmission parameters.

The parameters of transmission by the microcontroller 219, associated with each transmission queue, are computed:
as a function of a bandwidth reservation in the network for “stream mode buffer” type queues;
as a function of an estimation of the bandwidth available in the network for the “message mode buffer” type queues.

The transfer of data according to these two modes of transmission is described in the European patent application No. 01400316 and shall not be described in greater detail.

This data will come:
either from devices connected to the IEEE 1394 links such as for example the links referenced 121 to 124 (see FIG. 1-a);
or from analog devices (such as for example the one referenced 110 in FIG. 1-a) connected to the analog/digital converter 214 (for example a link 120 in the above-mentioned example;
or from a micro-computer type device connected to the Ethernet interface 216.

Should the audio-video analog data come, for example, from a device 110 connected to the access device 101 by means of an audio-video analog link 120, this data will be converted by the analog/digital converter 214 and then encoded in an MPEG2 format by the module 213. Then DV format may be used instead of the MPEG2 format. This encoded data will then be transmitted by means of the digital audio/video interface 209 and the bridge controller 208 to the transmission queue 201. DV is the abbreviated form of the SD-DVCR (Standard Definition Digital Video Cassette Recorder) format. MPEG2 is the acronym for the Motion Picture Expert Group 2.

Should the data come from a device connected to the access device by an IEEE 1394 type link such as the link 121, two types of processing will be carried out depending on the nature of the data. If this data is asynchronous type data, it will travel through the bridge controller 208 and then through the bus interface 204 and will finally be memorized in the memory 206. The microcontroller 219 transfers this data to a “message mode buffer” type of transmission queue 201 if this data is addressed to another access device of the network or to a device connected to another access device of the network. If the data is isochronous type data, it will travel directly to a “stream mode buffer” type of transmission queue 201.

Through the bus interface 204, the microcontroller 219 will also manage the distribution of data received by means of the Y link interface 221 and stored in the reception queue 202.

For isochronous type data stored in the reception queue 202, and depending on the destination of this data, the microcontroller 219 will activate the transfer of the data either to the IEEE 1394 link controller referenced 210 if this data is intended for at least one of the terminals connected to the bus 121 for example, or to the bridge controller 208 if this data is intended for an analog device connected to the link 125 for example.

For asynchronous type data stored in the reception file 202, the microcontroller 219 will activate the transfer of the data to the RAM 206 through the module 203 and the bus interface 204. The Ethernet type asynchronous data will then be sent to the interface 216.

The IEEE 1394 type asynchronous data addressed to a device connected to the same IEEE 1394 bus as the access device will then be sent to the interface referenced 211.

If the data is intended for a terminal connected to the link 125 for example, the microcontroller 219 will activate the transfer of this data to the audio/video digital interface 209 by means of the bridge controller 208. This MPEG2 (or DV) type data will then be decoded by the decoder 212 and finally transmitted to the analog/digital converter 215 which enables the transfer of the information in analog form to the analog device (the device 110 in this example) connected to the digital/analog converter 215 by the link 125.

The segmentation and reassembly module 203 controls the sending of the data in the form of packets from the transmission queues 201 towards the Y link interface 221. Each packet comprises a routing header as well as a packet type header (of the “message ” or “stream” type depending on the transmission queue). The routing and packet type information is configured by the microcontroller 219.

Furthermore, the segmentation and reassembly module 203 controls the reception of the packets from the Y link interface 204 in order to store the data as a function of the type of packet in the appropriate reception queue 202 which is either a “message mode buffer” or a “stream mode buffer” type of reception queue.

Besides, the access device 101 of FIG. 1-a includes a hard disk drive emulation module or HDD emulation module that provides a means to make the access device 101 connected to the IEEE 1394 bus 121). The AV HDD emulation module causes the access device to be perceived by the other IEEE 1394 type peripherals connected to the same IEEE 1394 bus as a classic 1394 IEEE type AV HDD (which corresponds to an IEEE 1394 type AV HDD emulation). The AV HDD emulation module however implements specific algorithms described further below.

In order that the access device may be perceived as an IEEE 1394 type AV HDD, the AV HDD emulation module must instantiate an adequate ROM configuration (cf. CSR or Control and Status Register architecture described by the IEEE 1212 standard) to present the access device 101 as an AV/C (audio-video/command) device whose specifications are described in the document “Configuration ROM for AV/C Devices 1.0”, 1394 Trade Association, 12 Dec. 2000.

The AV HDD emulation module also implements the AV HDD type AV/C functions and descriptors needed to manage the classic hard disk drive commands such as for example the commands PLAY, PLAY, PAUSE, STOP, etc. The specifications of the AV/C functions and descriptors are presented in the following documents:

“AV/C Digital Interface Command Set General Specification Version 4.1”, 1394 Trade Association, 11 Dec. 2001;

“AV/C Descriptor Mechanism Specification 1.1”, 1394 Trade Association, 20 Feb. 2002;

“AV/C Disc Subunit General Specification 1.1” 1394 Trade Association, 20 Feb. 2002;

“AV/C Disc Subunit-Hard Disk Drive Device Type”, 1394 Trade Association, 20 Feb. 2002.

The access device 101 furthermore provides a set of registers compliant with the IEEE 1394.1 standard (“Draft Standard for High-Performance Bus Bridges”, 1394 Trade Association, May 2004), thus making it possible to set up a connection between any source device of the network and the IEEE 1394 digital television set.

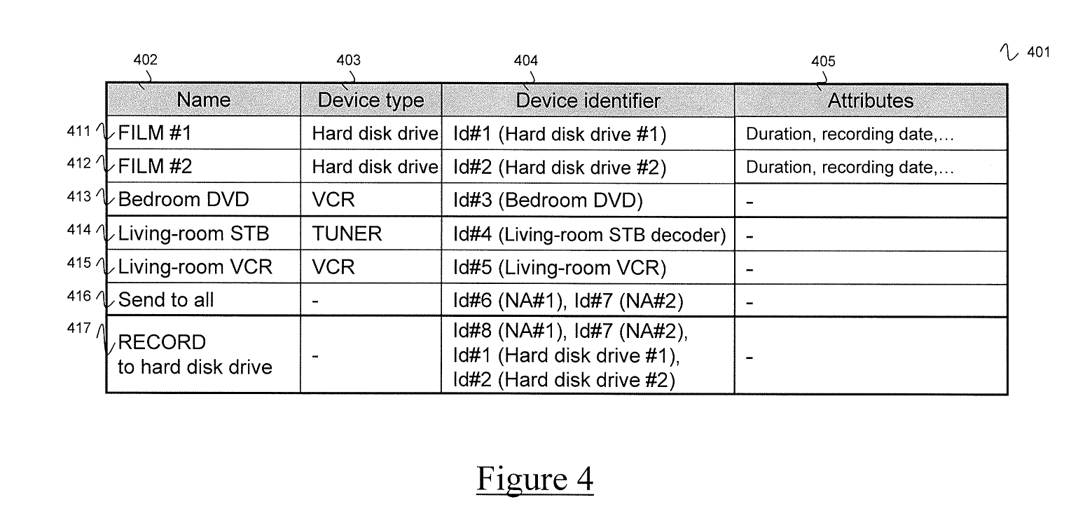

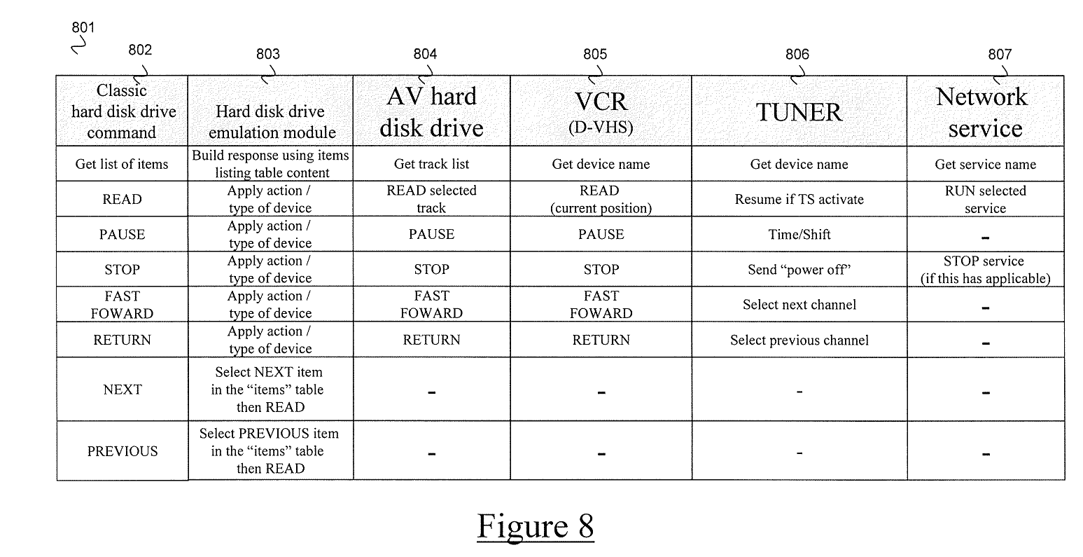

Thus, the access device 101 provides a contents emulation table 401 as well as an HDD commands correspondence table 801. Each of these two tables is described in greater detail here below in the description with reference to FIGS. 4 and 8.

The AV HDD emulation module and the above-mentioned tables (content emulation table and correspondence table) are actually software units stored in the flash memory 205 and/or in the RAM 206 and constitute a set of variables manipulated by the microcontroller 219.

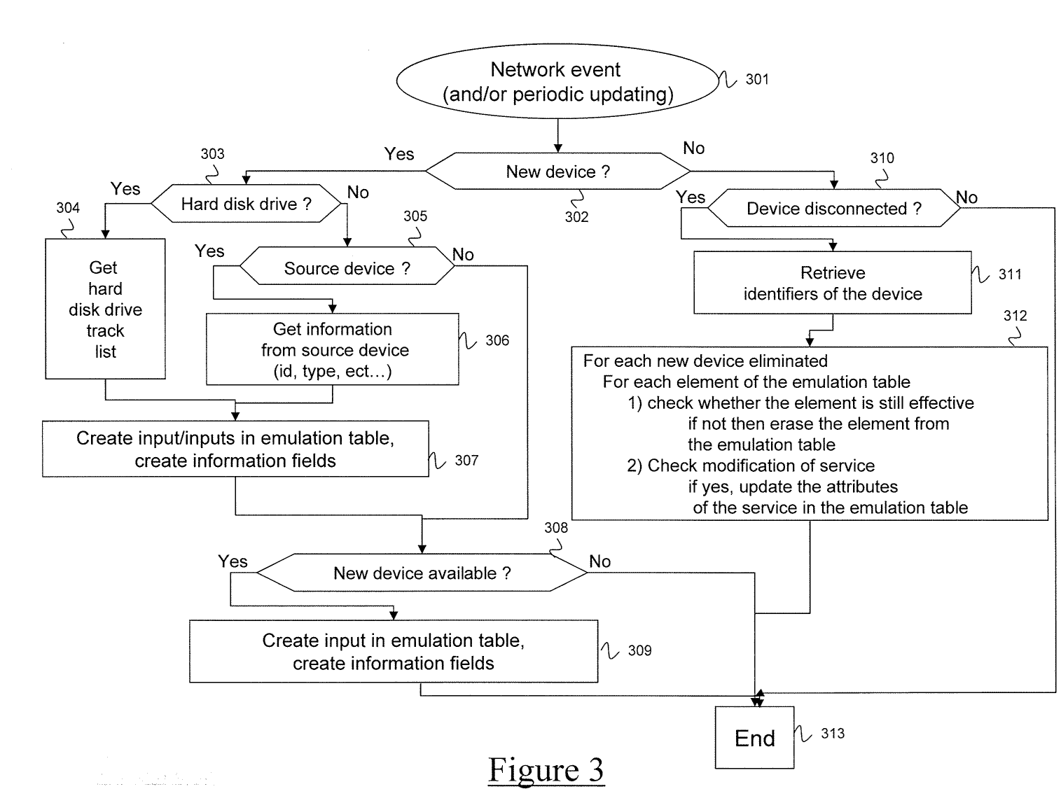

FIG. 3 is a flow chart showing the processing implemented by one of the access devices 101 to 104 for building and/or updating of a list of contents to be provided to a destination device upon reception of a set of commands in order to obtain a list of contents or tracks (“get track list” command described further below) according to the particular embodiment of the method of the invention.

The processing is done within the AV HDD emulation module by a processing algorithm.

When a network event 301 occurs, there is a potential need for updating the content emulation description table representing the contents of certain source devices, the source devices themselves and services provided by the communications network 100.

The network events may be based on technologies such as UPnP (“Universal Plug and Play”) or HAVi (“Home Audio Video Interoperability”), enabling the detection, for example, of the plugging in or unplugging of the device.

The network events 301 may result from the following different actions:
a new source device (for example a storage device, a sink device or an access device) has been plugged in or made visible on the network (for example subsequently to its being powered on) and therefore visible to the device that runs the AV HDD emulation module;
an existing source device has been unplugged or is no longer visible (for example, subsequently to its being powered off);
a list of tracks of a source device, for example an AV HDD, connected to the network 100 has changed, for example when the operations such as “record”, “delete”, etc are executed by the AV HDD.
a new network service is available, and an existing network service is no longer available.

The updating operation can also be activated periodically at regular intervals, for example every minute, or whenever the command or set of commands for obtaining a list of contents or tracks (“get track list” described here below) is received from the IEEE 1394 digital television set to which the access device is connected.

In a step 302, the AV HDD emulation module checks whether a new source device, for example a storage device (hard disk drive), a sink device or an access device, has been connected to the network.

In the event of a positive check result at the step 302, the AV HDD emulation module checks whether the new source device detected is a hard disk drive (step 303).

In the event of a positive check result at the step 303, the AV HDD emulation module retrieves (step 304) the list of tracks available on the detected hard disk drive as well as the information on each of these tracks (for example the title, the duration etc).

An AV HDD contains different information structures corresponding to a predetermined audiovisual content description format. Of these pieces of information, some are used to identify and describe the capacities of the disk drive while others (which may be related to one another) are used for example to describe the list of contents present in the disk drive such as for example: the root contents list structure which enables access to the contents recorded in the disk drive either directly or indirectly in using links to other structures called “child contents lists”. These structures contain either specific information structures called descriptors (or object descriptors). These structures will contain information blocks (“info blocks”) characterizing a given content: title of the content, size, position in the disk drive, time of creation etc). The various pieces of information pertaining to the contents recorded in the hard disk drive detected are retrieved by sending AV/C commands to the hard disk drive (AV HDD) in scanning the different lists described earlier and addressing information structures called descriptors (for example by means of the commands “OPEN”, “READ”, “CLOSE” etc).

Here below in the description, the “get track list” command (whether addressed to an AV HDD or to the AV HDD emulation module) therefore corresponds to the set of AV/C commands as described here above which can be used to obtain a list of contents or tracks compliant with the AV/C audio-visual content description format.

In the event of a negative check result at the step 303, the AV HDD emulation module checks (step 305) whether the detected source device is a source device other then a hard disk drive.

In the event of a positive check result at the step 305, the AV HDD emulation module retrieves (step 306) all the information (for example an identifier, an address, the type of device etc) that may be necessary to set up a network connection with this device and/or send the appropriate commands.

In a step 307, the AV HDD emulation module creates the necessary inputs in a content emulation description table in order to store the information obtained earlier at the step 304 (list of tracks) or 306 (information on source devices).

After the execution of the step 307, or when the new device is neither a hard disk drive nor a source device (step 305), the AV HDD emulation module checks (step 308) whether one or more new services have been made available following the plugging in of a new device.

For example, when a DVD recorder type device is plugged into the network 100 and a “burn DVD” type service is provided by the network 100 through its access devices, this service becomes available to the user and a new input has to be created, following the plugging in of this destination device, to represent the availability of this service and enable the user to access it.

In the event of a positive check result at the step 308, one or more new inputs are created (step 309) and information fields are filled with the appropriate data (for example the name of the service, the access device or devices and/or source devices involved in the service, the values of the attributes for a particular service etc).

In the event of a negative check result at the step 308, the processing algorithm of FIG. 3 stops (step 313).

In the event of a negative check result at the step 302 (where no new device has been detected), the AV HDD emulation module checks (step 310) whether one or more source devices have been unplugged from the communications network 100.

In the event of a negative check result at the step 310, the processing algorithm stops (step 313).

In the event of a positive check result at the step 310, the unplugged source devices are first of all identified (step 311). In a step 312, the AV HDD emulation module then verifies, for each unplugged source device, each element of the content emulation description table (described in detail here below with reference to FIG. 4) in order to check the following:
whether or not the element is still effective. Should this element be no longer effective, it is deleted from the content emulation description table. For example:
   if a hard disk drive type of source device has been unplugged from the communications network 100, all the tracks (or contents) stored in the hard disk drive are deleted from the contents emulation description table;
   if a source device other than a hard disk drive (for example a set top box) has been unplugged from the communications network 100, the element representing this source is deleted from the content emulation description table;
   if an access device has been unplugged, every source device (including every hard disk drive and associated contents) connected to this access device is de facto unplugged and an updating of the content emulation description table becomes accordingly necessary.
if the services given by the network are affected (i.e. for example, if they are modified through the addition of a device to the network 100 or the removal of a device from the network 100, or are simply not available). If this is the case, then the element or elements representing the service is/are either updated or eliminated from the contents emulation description table, as for example:
   if a hard disk type source device, called for example a “living-room HDD”, has been unplugged from the communications network 100, the “record to living-room HDD” must be deleted from the contents emulation description table and the element “record to HDD” must also be deleted from the contents emulation description table if no other hard disk drive is present in the network;
   if an access device has been unplugged, every service involving this access device is thereby affected and an updating of the contents emulation description table therefore becomes necessary. For example, the service “send to all” is modified, as the list of destination access devices has been reduced.

The contents emulation description table may also be updated following the addition or elimination of services provided by the network (not shown in FIG. 3). For example, a service may come into conflict with an operation in progress on the network and be made temporarily unavailable. This is the case when a “record to DVD” service enabling the recording of a content to a DVD storage unit through a DVD recorder connected to the network is being used on the network. This service could then be temporarily eliminated from the contents emulation description table so as to be made inaccessible to the user through the IEEE 1394 digital television set during the time taken to complete the recording operation in progress.

Once the contents emulation description table has been updated, the processing algorithm stops (step 313).

FIG. 4 shows a contents emulation description table 401 created, used and updated by an access device according to a particular embodiment of the invention. The contents emulation description table 401 includes information taken into account during the creation of the responses intended for the IEEE 1394 digital television set, in response to the different requests (or AV/C commands) generated in order to obtain the list of tracks (or contents) present in the access device (emulating the behaviour of an AV HDD).

The AV HDD emulation module is in charge of the emulation, from the table 401, of the different information structures addressed by the AV/C commands. The purpose of this is to enable the IEEE 1394 digital television set to retrieve the contents as if they were actually located in an AV HDD.

The information contained in the responses to the AV/C request addressed to the descriptors (emulated by the AV HDD emulation module) include especially the name of the element 402 presented as a content (or track) name when it is displayed on the graphic user interface of the IEEE 1394 digital television set.

The information on the type of source device 403 is necessary in order to enable the application of an appropriate processing as defined in the HDD commands correspondence table described here below with reference to FIG. 8.

Furthermore, the piece of information 404 for identification of the source device is used to identify and address the access device or devices in charge of executing one or more appropriate operations depending on the command received.

For example, for an IEEE 1394 device, the information for identification of the source device may consist of a unique worldwide identifier called EUI-64(“64 bit-Extended Unique Identifier”, the global address or “global ID” according to the IEEE 1394.1 standard) of the IEEE 1394 device, proper to the network, capable of being retrieved from this unique identifier.

In the case of a Ethernet type device, the piece of identification information consists of a MAC (media access control) address, it being thus possible to retrieve the IP address.

Finally, a piece of information 405 on the attributes enables the storage of complementary information pertaining to attributes or capacities that may be useful in the execution of an appropriate processing. For example, when obtaining a piece of information coming from an AV HDD type source device for a given track, complementary information other than the title may also be useful, for example information such as duration of the track, date of recording, memory space remaining for the recording etc. There is for example:
the name of the element 411 “film No. 1” corresponds to the name of a track of an AV HDD, the type of source device is a “hard disk drive” (AV HDD) and the content identified by the element 411 is contained in the “hard disk drive No. 1” whose identifier is referenced “Id No. 1”;
the name of the element 414 “living-room STB decoder” corresponds to the name of a “tuner” type source device whose identifier is referenced “ID No. 4”;
the name of the element 416 “send to all” is a service provided by the network that makes it possible to send the content currently viewed on the display device (such as an IEEE 1394 digital television set) connected to the current access device (the access device comprising the table 401 described) to other display devices connected to the access device No. 1 (whose identifier is referenced “ID No. 6”) and to the access device No. 2 (whose identifier is referenced “ID No. 7”);
the name of the element 417 “record to HDD” is a service provided by the network enabling recording to the hard disk drive No. 1 by means of the access device No. 1 (whose identifier is referenced “ID No. 6”) or to the hard disk drive No. 2 by means of the access device No. 2 (whose identifier is referenced “ID No. 7”).

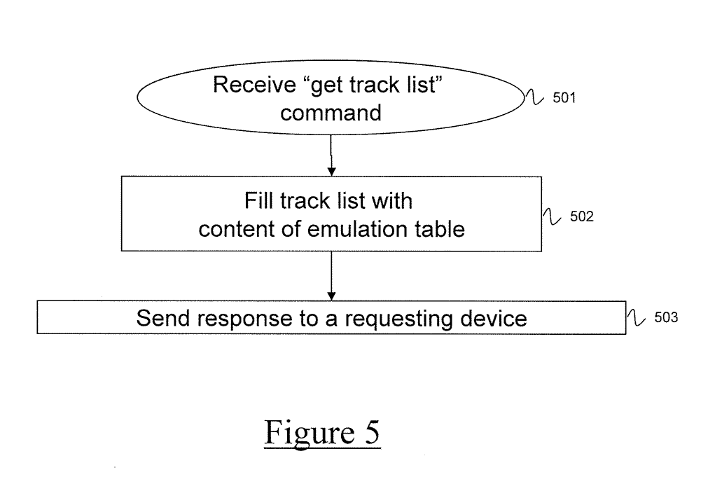

FIG. 5 is a flowchart of processing implemented by an access device for the execution of the “get track list” command (more specifically the set of AV/C commands such as those used to obtain a list of contents of tracks) according to a particular embodiment of the method of the invention.

In a classic way, using a remote control unit placed at his disposal, the user sends commands to an IEEE 1394 digital television set to obtain a list of apparatuses present on the IEEE 1394 bus to which the digital television set is connected. The user can then select one apparatus from this list and apply a set of commands depending on the type of source device selected. These commands are transmitted to the IEEE 1394 device by means of dedicated AV/C requests (commands). In the particular embodiment of the invention, the digital television set will export the access device into its user interface as an AV HDD owing to the presence of the AV HDD emulation model within the access device.

In a step 501, the access device sequentially receives the AV/C commands coming from the digital television set in order to obtain the list of available tracks. As specified here above, the AV HDD emulation module is responsible for emulating the different information structures addressed by the AV/C commands (namely the “root contents list” structures, possibly the “child contents list” structures as well as all “descriptor” information structures corresponding to the emulated contents).

In a step 502, the AV HDD emulation module uses the content of the content emulation description table 401 to build the responses to the different AV/C commands intended for the destination device (having generated the request) during a step 503. The destination device, i.e. the IEEE 1394 digital television set, will interpret these responses.

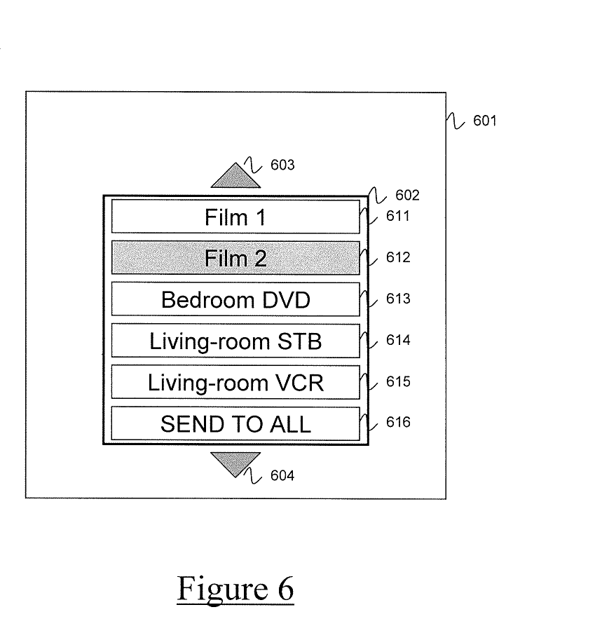

FIG. 6 shows a part of an example of a graphic user interface of an IEEE 1394 digital television set according to a particular embodiment of the invention used to view the list of contents obtained during the step 503 at a user's request.

Most IEEE 1394 digital television sets are capable of managing IEEE 1394 storage devices such as D-VHS digital videocassette recorders or audio-video hard disk drives (AV HDD).

When the access device is selected by the user as a source of the IEEE 1394 digital television set, the access device is presented as being an IEEE 1394 type AV HDD through of the AV HDD emulation module that it contains. The digital television set then uses, for example, a list 601 of the graphic user interface thus enabling the viewing, in a display window 602, of the list of elements 611 to 616 received by the access device. This list then presents the user, as described here above, not only with the contents available on the AV HDD type source devices connected to the network 100 but also the other source devices connected to the network 100 as well as the services provided by the network 100.

The size of the display window and the number of tracks displayed in the window may vary from one IEEE 1394 digital television set to another.

Such a list coming from the graphic user interface also provides navigation means such as the upward arrow 603 or the downward arrow 604 to highlight and select one of the elements of the list.

When a user moves the cursor of the graphic user interface on to one element (for example the element 612) of the list 601, this element 612 is highlighted; for example it is highlighted in a colour different from that of the background. The user can then select it and make a request for reading the associated content. This read request, sent by the IEEE 1394 digital television set, will lead to the following on the part of the access device depending on the selected element of the list 601: the setting up of a connection to an AV HDD type source device of the network 100 and the reading of the identified content by the list element 601, the setting up of a connection to a source identified by the list element 601 or the activation of a service provided by the network identified by the list element 601. Any command sent subsequently to the access device (more specifically to the AV HDD emulation module) is then applied to the selected track (or element) according to the HDD commands correspondence table described here below with reference to FIG. 8.

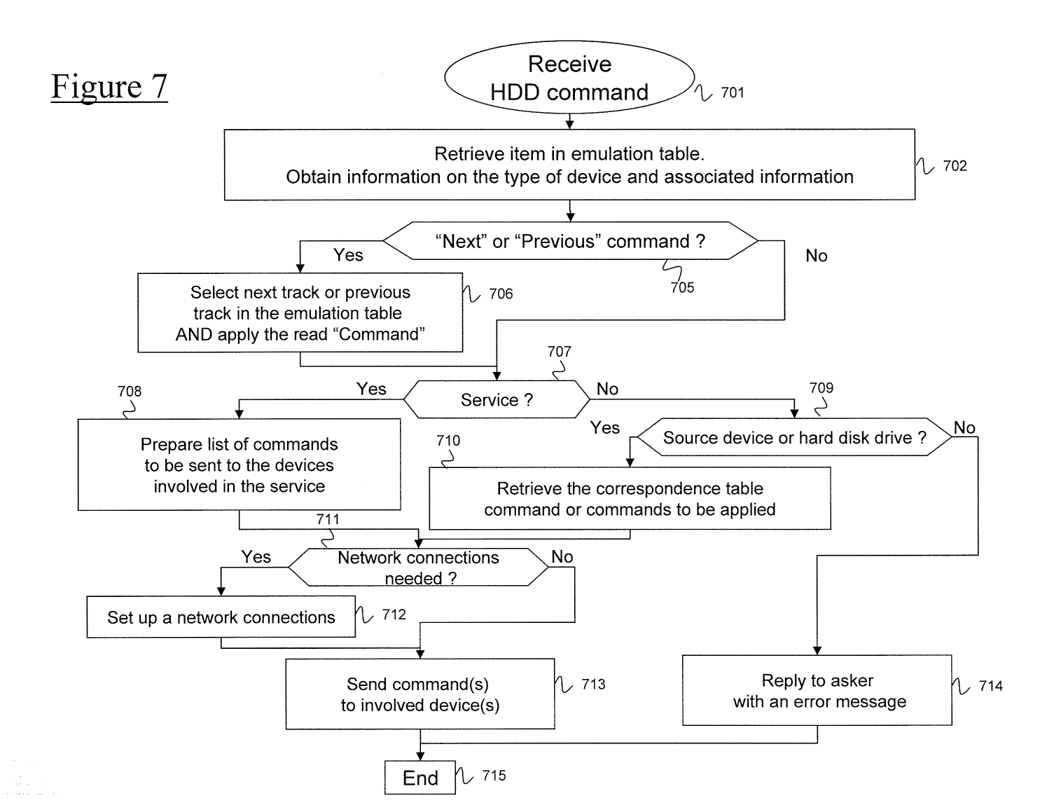

FIG. 7 is a flowchart showing the processing of a command implemented by an access device according to a particular embodiment of the method of the invention.

It is assumed that, through the graphic user interface of the television set, the user has selected one element from the list 601 then activated one command from among the classic hard disk drive control commands.

The processing of this command is done by means of a processing algorithm executed within the AV HDD emulation module of the access device. An IEEE 1394 type AV HDD generally includes a list of commonly used predefined commands, example play, pause, stop, fast forward (FF) fast rewind (FR), next track, previous track.

In a step 701, the AV HDD emulation module receives the command to be applied as a function of an element selected from the list 601 (which corresponds to the graphic representation of the list returned by the AV HDD emulation module at the step 503).

In a step 702, the HDD emulation module first of all retrieves the type and information on identification of the device or devices concerned by the selected element from the content emulation description table 401.

The emulation module checks (step 705) whether the “previous track” or “next track” command has been received.

In the event of a positive check result at the step 705, the AV HDD emulation module must select (step 706) either the next element or the previous element from the content emulation description table and must then execute the hard disk drive command or HDD command “play” to activate the selected element (as if the HDD command “late” had been sent to the newly selected element).

In a step 707, the AV HDD emulation module checks whether the selected item is a network service.

In the event of a positive check result at the step 707, a list of commands to be sent to the different devices involved in the selected network service is prepared (step 708) on the basis of the information contained in the content emulation description table.

Once the list of commands has been prepared, the processing algorithm reaches a step 711 described here below.

In the event of a negative check result at the step 707, the AV HDD emulation module checks (step 709) whether the selected element involves a hard disk drive type source device or a source device of a different type (for example a set-top box).

In the event of a negative check result at the step 709, an error message is sent back to the asker (step 714) and the processing algorithm stops (step 715).

In the event of a positive check result at the step 709, a specific table called an HDD commands correspondence table, described here below with reference to FIG. 8, is used in order to retrieve the appropriate command or commands (step 710) that need to be applied to the source device. The commands to be applied are selected as a function of the type of source device (an HDD type device being a particular source device) and depending on the HDD command received from the destination device at the step 701 (i.e. the IEEE 1394 digital television set).

In a step 711, the AV HDD emulation module checks whether there is need to set up one or more network connections. It makes this check as a function of the operation to be performed in correspondence with the HDD command received from the destination device at the step 701 and the localization of the device or devices involved in the network 100.

In the event of a positive check result at the step 711, the connection connections are set up (step 712).

In the event of a negative check result at the step 711, the processing algorithm reaches a step 713.

Finally, at the step 713, the AV HDD emulation module sends the appropriate commands to the predetermined devices involved in the execution of the requested service for the execution of an operation by the source device (for example of the hard disk drive type).

For example, if the selected element is “record to HDD”, the access device identifies the source whose content is being viewed by the digital television set (the last element in the chronology of the connections to the IEEE 1394 digital television set), to then set up a connection of the identified source to a hard disk drive available on the network 100 and to finally send the command “record” to the selected hard disk drive.

To set up a connection between a source device and a destination device (which may be the IEEE 1394 digital television set itself, a recording device, another television set to which the user transfers a content, etc), the access device acts like a stream controller according to the specifications of the IEEE 1394.1 standard (refer to the document IEEE 1394.1 document “Draft Standard For High-Performance Bus Bridges”, May 2004). The access device sends a message of the “JOIN” type and performs an appropriate processing operation in order to allocate resources adapted to the transport of the data stream from the source to the destination.

A “LEAVE” type message according to the IEEE 1394.1 specifications is then used similarly, when the controller has to stop the connection according to the corresponding instructions coming from the IEEE 1394 digital television set or when a service is automatically interrupted (end of execution of the service).

The processing algorithm then stops in a step 715.

FIG. 8 presents a correspondence table of HDD commands used by an access device according to a particular embodiment of the invention.

The correspondence table 801 defines a rule of correspondence between the commands of the AV HDD type devices and the commands to be applied as a function of the source device, the content or the service represented by the elements selected from the list of contents provided by the access device to the destination device upon a “get track list” request.

The HDD command correspondence table 801 used in the step 710 of the processing algorithm of FIG. 7 is therefore used to apply the appropriate processing based on the 802 type HDD command sent by the IEEE 1394 television set and the type 804 to 807 of selected element.

The first column 802 of the correspondence table 801 describes the frequently used commands such as, for example: play, pause, stop, fast forward, return, next track, previous track.

For each of the commands pertaining to an HDD, the AV HDD emulation module applies the appropriate actions. It may, for example, either launch particular processing operations (i.e. specific requested actions to build the list of contents to be returned to the IEEE 1394 digital television set from the contents emulation description table 401) or apply a particular command which depends on the type of device.

For example, as described here above, in order to create the list of contents requested by the IEEE 1394 digital television set, the AV HDD emulation module is entrusted with retrieving the right information from the different devices of the network, for example the list of tracks or contents for an AV HDD type source device, the name and identifier for a source device other than a hard disk drive (for example an STB decoder, a DVD player, a VCR videocassette recorder), the name of the service provided by the network 100 and the devices and actions involved by this service.

Thus, when it receives a “play” command from the IEEE 1394 digital television set, the HDD emulation module sends the command “play” to the source device in the case of an AV HDD or a VCR videocassette recorder, or resumes the viewing of a content in the case of an STB decoder if the “time shift” function (used to view a content received by cable or satellite with a time shift) has been activated beforehand.

Thus, from a IEEE 1394 digital television set that simply enables the control (and viewing of the contents) of a limited number of IEEE 1394 devices present on the same IEEE 1394 bass as itself, the invention enables the control (and display of the contents) on devices present on other IEEE 1394 buses of the network 100 and also makes it possible to access a set of services provided by the network 100.

1. Method for the management of devices in a communications network comprising at least one source device and at least one destination device, said destination device or devices being interconnected to said source device or devices by means of at least one other device of said network, called an access device or devices,
wherein the following steps are implemented by an access device compatible with a predetermined audiovisual content description format:
reception of a request, coming from a destination device, called a requesting destination device, for obtaining a list of audiovisual contents available on said access device;
creation of a list, called a requested list, comprising a piece of information representing at least one source device, said representative information being described according to said audiovisual content description format;
in response to said request, sending said requesting destination device the list created during the creation step.

2. Method for the management of devices according to claim 1 wherein, prior to the step of creation of the requested list, the device management method comprises the following step:
determining at least one source device which is a storage device, on which at least one audiovisual content is available,
and wherein the requested list furthermore comprises a piece of information representing said audiovisual content or contents available on said determined storage device or devices.

3. Method for the management of devices according to claim 2, wherein the piece of information representing said determined storage device or devices is excluded from the requested list.

4. Method for the management of devices according to claim 1 wherein, prior to the step of creation of the requested list, the device management method comprises a step for determining at least one service available on the network,
and wherein the requested list furthermore comprises a piece of information representing said determined service or services, said representative piece of information being described according to said audiovisual content description format.

5. Method for the management of devices according to claim 1, wherein it comprises a preliminary step for the declaration of said access device as a storage device of a predetermined type, said reception step and said sending step being performed according to a standard protocol for the control of a storage device of said predetermined type.

6. Method for the management of devices according to claim 1, wherein it furthermore comprises the following steps:
reception of a first control request, coming from said requesting destination device, associated with an element, called a selected element, of the requested list;
determining a content, a source device or a service available on the network called a represented element, the selected element of which is the piece of representative information;
determining the operations to be performed as a function of the determined content, source device or service and of the control request received.

7. Method for the management of devices according to claim 6 wherein the step for determining the operations to be performed comprises the following step, should the represented element to be a source device: p1 sending to said source device a command corresponding to the received control request, according to a rule of correspondence between received requests and commands applicable to said source device.

8. Method for the management of devices according to claim 6, wherein the step for determining the operations to be performed comprises the following steps should the represented element be a content:
determining a storage device on which said content is stored;
determining whether a stream connection has been set up between said storage device and the requesting destination device;
if the determining result is negative, sending a request for setting up a stream connection between said storage device and the requesting destination device;
sending to said storage device a command corresponding to the control request received, according to a rule of correspondence between received requests and commands applicable to said storage device.

9. Method for the management of devices according to claim 6, wherein the step for determining the operations to be performed comprises the following steps if the represented element is a service:
determining at least one source device and at least one destination device of which said service is a function;
determining at least one stream connection to be set up between said source device or devices and said determined destination device or devices, in order to perform said service;
sending at least one request for setting up said stream connection or connections.

10. Method for the management of devices according to claim 9, wherein it furthermore comprises the following step:
sending to at least one of said source devices and said determined destination devices, called service device or devices, a command corresponding to the control request received according to a rule of correspondence between received requests and commands applicable to said service device or devices.

11. Method for the management of devices according to claim 1, wherein said requesting destination device is an IEEE 1394 type display device

12. Computer program product downloadable from a communications network and/or recorded on a carrier readable by computer and/or executable by a processor wherein it comprises program code instructions for the execution of the steps of the device management method according to at least one of the claims 1 to 11, when said program is executed on a computer.

13. A totally or partially detachable storage means, readable by a computer, storing a set of instructions executable by said computer to implement the device management method according to at least one of the claims 1 to 11.

14. Access device compatible with a predetermined audiovisual content description format interconnecting one or more destination devices to one more source devices within a communications network, wherein it comprises:
means of reception of a request, coming from a destination device, called a requesting destination device, for obtaining a list of audiovisual contents available on said access device;
means of creation of a list, called a requested list, comprising a piece of information representing at least one source device, said representative information been described according to said audiovisual content description format;
means of sending said requesting destination device, in response to said request, the list created during the creation step.

15. An access device according to claim 14, wherein it comprises means for determining at least one source device which is a storage device, on which at least one audiovisual content is available,
and wherein the requested list furthermore comprises a piece of information representing said audiovisual content or contents available on said determined storage device or devices.

16. Access device according to claim 15, wherein it comprises means for the exclusion, from the requested list, of the piece of information representing said determined storage device or devices.

17. Access device according to claim 14, wherein it comprises means for determining at least one service available on the network,
and wherein the requested list furthermore comprises a piece of information representative of said determined service or services, said representative piece of information being described according to said audiovisual content description format.

18. Access device according to claim 14, wherein it comprises means for the declaration of said access device as a storage device of a predetermined type, and wherein said reception means and said sending means implement a standard protocol for the control of a storage device of said predetermined type.

19. Access device according to claim 14, wherein it furthermore comprises:
means of reception of a first control request, coming from said requesting destination device, associated with an element, called a selected element, of the requested list;
means of determining a content, a source or a service available on the network, called a represented element, the selected element of which is the piece of representative information;
means of determining the operations to be performed as a function of the determined content, source device or service and of the control request received.

20. Access device according to claim 19, wherein said means of determining the operations to be performed comprise, should the represented element to be a source device, means of sending said source device a command corresponding to the received control request, according to a rule of correspondence between received requests and commands applicable to said source device.

21. Access device according to claim 19, wherein the means for determining the operations to be performed comprise, should the represented element be a content:
means of determining a storage device on which said content is stored;
means of determining if a stream connection has been set up between said storage device and the requesting destination device;
if the determining result is negative, means of sending a request for setting up a stream connection between said storage device and the requesting destination device;
means of sending said storage device a command corresponding to the control request received, according to a rule of correspondence between received requests and commands applicable to said storage device.

22. Access device according to claim 19, wherein the means of determining the operations to be performed comprise the following if the represented element is a service:
means of determining at least one source device and at least one destination device of which said service is a function;
means of determining at least one stream connection to be set up between said source device or devices and said determined destination device or devices, in order to perform said service;
means of sending at least one request for setting up said stream connection or connections.

23. Access device according to claim 22, wherein it furthermore comprises means of sending to at least one of said source device or devices and said determined destination device or devices, called service device or devices, a command corresponding to the received control request, according to a rule of correspondence between received requests and commands applicable to said service device or devices.

24. Access device according to claim 14, wherein said requesting destination device is an IEEE 1394 type display device.
